(19) United States
(12) Patent Application Publication
(10) Pub. No.: US 2014/0279901 A1
(43) Pub. Date: Sep. 18, 2014

(54) Mobile Data Synchronization

(71) Applicant: NEC Laboratories America, Inc., Princeton, NJ (US)

(72) Inventors: Nitin Agrawal, East Brunswick, NJ (US); Akshat Aranya, Jersey City, NJ (US); Cristian Ungureanu, Princeton, NJ (US)

(73) Assignee: NEC Laboratories America, Inc., Princeton, NJ (US)

(21) Appl. No.: 14/205,787

(22) Filed: Mar. 12, 2014

Related U.S. Application Data
(60) Provisional application No. 61/777,194, filed on Mar. 12, 2013.

(51) Int. Cl. G06F 17/30

(52) U.S. Cl. CPC G06F 17/30575
USPC 707/634

(57) ABSTRACT

Disclosed are methods and structures that facilitate the synchronization of mobile devices and apps with cloud storage systems. Our disclosure, Simba, provides a unified synchronization mechanism for object and table data in the context of mobile clients. Advantageously, Simba provides application developers a single, API where object data is logically embedded with the table data. On the mobile device, Simba uses a specialized data layout to efficiently store both table data and object data. SQL-like queries are used to store and retrieve all data via a table abstraction. Simba also provides efficient synchronization by splitting object data into chunks which can be synchronized independently. Therefore, if only a small part of an object changes, the full object need not be synced. Advantageously only the changed chunks need be synched.

### CROSS REFERENCE TO RELATED APPLICATIONS

This application claims the benefit of U.S. Provisional Patent Application No. 61/777,194 filed Mar. 12, 2013.

### TECHNICAL FIELD

This disclosure relates generally to the field of computer software systems and in particular to methods and structures for the synchronization of data between mobile device(s) and cloud storage systems.

### BACKGROUND

As is known, mobile applications are becoming increasingly data-centric—oftentimes relying on cloud infrastructure to store, share and analyze data. Consequently application developers (App Developers) have to frequently manage local storage contained within a mobile device (e.g., SQLite databases, local filesystems) as well as any data synchronization with cloud storage systems. Consequently the development of methods and structures that facilitate this synchronization between mobile devices, mobile applications and cloud storage systems would represent a welcome addition to the art.

### SUMMARY

An advance is made in the art according to an aspect of the present disclosure directed to methods and structures that facilitate the synchronization of mobile devices and apps with cloud storage systems. Our disclosure, Simba, provides a unified synchronization mechanism for object and table data in the context of mobile clients. Advantageously, Simba provides application developers a single, API where object data is logically embedded with the table data.

On the mobile device, Simba uses a specialized data layout to efficiently store both table data and object data. SQL-like queries are used to store and retrieve all data via a table abstraction. Simba also provides efficient synchronization by splitting object data into chunks which can be synchronized independently. Therefore, if only a small part of an object changes, the full object need not be synchronized. Advantageously only the changed chunks need be synchronized.

Viewed from one aspect, the present disclosure is directed to a unified API for synchronizing mobile devices with cloud storage.

### BRIEF DESCRIPTION OF THE DRAWING

A more complete understanding of the present disclosure may be realized by reference to the accompanying drawings in which:

FIG. 1 is a schematic diagram of a Simba client architecture for mobile synchronization according to the present disclosure;

FIG. 2 is a schematic diagram showing Simba client data store using an SQL database and Object store according to an aspect of the present disclosure;

FIG. 3 is a schematic diagram showing Simba client synchronization in (a) an initial synchronized state and (b) changes on the server assigned sequential versions based on table version according to an aspect of the present disclosure; and

FIG. 4 is a Table 1 showing data synchronization needs of mobile applications according to an aspect of the present disclosure;

FIG. 5 is a Table 2 showing Simba Client API operations available to mobile apps for managing table and object data according to an aspect of the present disclosure; and

FIG. 6 is a schematic block diagram depicting an exemplary computer system and associated structures for executing systems, structures and methods according to an aspect of the present disclosure.

### DETAILED DESCRIPTION

The following discussion merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we note that as Mobile devices are quickly becoming the predominant means of accessing the Internet. For a growing number of users, wired desktops are giving way to smartphones and tablets using wireless mobile networks. A recent report forecasts 66% annual growth of mobile data traffic over the next 4 years.

Of particular interest, mobile platforms such as iOS, Android, and Windows Phone are built upon a model of local applications (which we generally refer to as “Apps”) that work with web-content. While web apps exist, a majority of smartphone usage is driven through native apps made available through their respective marketplaces which have over 700,000 apps available.

A large number of mobile apps rely on cloud infrastructure for data storage and sharing. Additionally, apps require local storage to deal with intermittent connectivity and high latency of network access. Local storage is frequently used as a cache for cloud data, or as a staging area for locally generated data. Traditionally, mobile app developers requiring such synchronization have to deploy their own implementation which often have similar requirements across apps namely, managing data transfers, handling network failures, propagating changes to the cloud and to other devices, and detecting and resolving conflicts. In a mobile marketplace targeted towards a large developer community, expecting every developer to be an expert at building infrastructure for data syncing is not ideal. Mobile developers should be able to focus on implementing the core functionality of apps.

As is known, App software development kits (SDKs) for contemporary mobile operating systems (for example, Android and iOS) provide two kinds of data storage abstractions to developers namely, table storage for small, structured data, and file systems for larger, unstructured objects such as images and documents.

For some mobile apps it is generally sufficient to synchronize only structured data; for example, RSS and News Readers (FeedGoal, Google Reader), simple note sharing (SimpleNote), and some location-based services (Google Places, Foursquare). Recently, a few systems have been proposed that attempt to provide synchronized table stores to aid such apps.

For other apps, synchronization of file data alone is sufficient. For example, SugarSync, Dropbox, and Box. Services such as Google Drive and iCloud simplify data management for mobile apps requiring file synchronization. However, of all the apps that require data storage and synchronization, only a subset deals with structured data only, or object data only; the large majority of apps operate both on structured and object data. Table 1—shown in FIG. 4—lists a few popular categories of such types of apps.

As may be readily appreciated, a data model employed oftentimes comprises application metadata (stored in SQLite tables) and object data such as files, cache objects, and logs (stored in the file system). In contemporary mobile systems, an app developer is responsible for ensuring that the two kinds of data are accessed, updated and synced consistently.

Existing approaches to synchronization of mobile apps exhibit several shortcomings. First, it is onerous for the app developers to maintain data in two separate services, possibly with different synchronization semantics. Second, even if they do maintain data in two separate services, apps cannot easily build a data model that requires table data to rely on object data and vice versa. For example, any dependency between table and file system data will have to be handled by the app. Third, by having two separate conduits for data transfer over a wireless network, apps do not benefit from coalescing and compression to the extent possible by combining the data. To address these shortcomings we describe Simba, a unified table and object synchronization platform specific for mobile apps development. As we shall describe, Simba advantageously applies several optimizations to efficiently sync data over network resources.

### Mobile Data Sync Services

Data synchronization for mobile devices has been studied in the past. Coda was one of the earliest systems to motivate the problem of maintaining consistent file data for disconnected “mobile” users. Other research, particularly in the context of distributed file systems, has looked at several issues in handling data access for mobile clients, including caching, and weakly-consistent replication.

A few systems provide a CRUD (Create, Read, Update, Delete) API to a synchronized table store for mobile apps. Mobius and Parse provide a generic table interface for single applications, while Izzy works along multiple apps reaping additional net work benefits through delay-tolerant data transfer. None of these systems support large object synchronization.

One option could be to embed large objects inside the tables of these systems. Even though such systems support binary objects (BLOBs), there is an upper limit to the size of the object that can be stored efficiently. Also, BLOBs cannot be modified in-place; objects would thus need to be split into smaller chunks and stored in multiple rows, requiring further logic to map large objects to multiple rows and manage their synchronization.

Services such as Google Drive, Box, and Dropbox are primarily intended for backup and sharing of user file data. Even though they provide an API for third-party apps (not just users), it only provides file sync. iCloud provides both file and key-value sync APIs, but the app still has to manage them separately.

### Unifying File Systems and Databases

Simba provides a unified storage API for structured and object data. Notably, there have been several attempts to unify file systems and databases, albeit with different goals. One of the earlier works, the Inversion File System, uses a transactional database, Postgres, to implement a file system which provides transactional guarantees, rich queries, and fine-grained versioning. Amino provides ACID semantics to a file system by using BerkeleyDB internally. TableFS is a file system that internally uses separate storage pools for metadata (a Log Structured Merge—LSM tree) and files (the local file system). Its intent is to provide better overall performance by making metadata operations more efficient on the disk. Recently, KVFS was proposed as a file system that stores file data and file-system metadata both in a single key-value store built on top of VT-Trees, a variant of LSM trees. VT-Tree by itself enables efficient storage for objects of various sizes.

### Mobile Data Sync Made Easy

While systems discussed above provide helpful insights into data sync, and in using database techniques for designing file systems, building a storage system for mobile platforms introduces new requirements. First, mobile data storage needs to be sync friendly. Since frequent cloud sync is necessary, and disconnected operation is often the norm, the system must support efficient means to determine changes to app data between synchronization attempts. Second, traditional file systems are not designed with mobile-specific requirements. Features such as hierarchical layout and access control are less relevant for mobile usage since data typically exists in application silos (both in iOS and Android); data sharing across apps is made possible through well-defined channels (e.g., Content Providers in Android), and not via a file system

Since the majority of user data is accessed through apps, a mobile OS needs a storage system that is more developer-friendly than user-friendly and should provide APIs that ease app development; we thus identify the following design goals:
Easy application development: provide app developers with a simple API for storing, sharing, and synchronizing all application data, structured or unstructured. The synchronization semantics should be well-defined, even under disconnection, and if desired, should preserve atomicity of updates.
Sync-friendly data layout: store app data in a manner which makes it efficient to read, query, and identify changes for synchronization with the cloud.
Efficient network data transfer: use as little network resources as possible for transferring data as well as control messages (e.g., notifications).

### Simba Design

Simba comprises of two main components: a client app providing a data API to other mobile apps, and a scalable cloud store. FIG. 1 shows the simplified architecture of the client, called Simba Client. Simba Client provides apps with access to their table and object data, manages a local replica of the data on the mobile device to enable disconnected operation, and communicates with the cloud to push local changes and receive remote changes.

The server-side component, called Simba Cloud, provides a storage system used by the different mobile users, devices, and apps. Simba Cloud mirrors most of the client functionality and additionally provides versioning, snapshots, and de-duplication. In this disclosure we focus on the design of the client and only discuss the server as it pertains to the client operation (FIG. 1 omits the server architecture).

Simba Client is a daemon accessed by mobile apps via a local RPC mechanism. We use this approach instead of linking directly with the app to be able to manage data for all Simba-enabled apps in one central store and to use a single TCP connection to the cloud. The local storage is split into a table store and an object store (described later). SimbaSync implements the data sync logic; it uses the two stores together to determine the changes that need to be synced to the server. For downstream sync, SimbaSync is responsible for storing changes obtained from the server into the local stores. SimbaSync also handles conflicts and generates notifications through API upcalls. The Network Manager handles the network connectivity and implements the network protocol required for syncing; it also uses coalescing and delay-tolerant scheduling to judiciously use the cellular radio

### Data Model

Simba has a data model that unifies structured table storage and object storage; we chose this model to address the needs of typical cloud-dependent mobile apps. The Simba Client API allows the app to write object data and associated table data at the same time. When reading data, the app can look up objects based on queries. While permitted, objects are not required; Simba can be used for managing traditional tabular data.

Table 2 in FIG. 5 lists the Simba Client API pertaining to table management, data operations, and synchronization. For the sake of brevity, we do not discuss notifications and conflict resolution any further. The first set of methods, labeled CRUD, are database-like operations that are popular among Android and iOS developers. In our design, we extend these calls to include object data. In our implementation, object data is accessed through the Java stream abstraction. For instance, when new rows are inserted, the app needs to provide an InputStream for each contained object from which the data store can obtain the object data. Using streams is important for memory management; it is impractical to keep entire objects in memory. A stream abstraction for Objects also allows seeking and partial reads and writes. The writeData( ) and updateData( ) always update the local store atomically, but they have an additional atomic sync flag, which indicates whether the entire row (including the object) should be atomically synced to the cloud. The second set of methods is used for specifying the sync policies for read (downstream) and write (upstream) sync; Simba syncs data periodically.

In the downstream direction, the server uses push notifications to indicate availability of new data and Simba Client is responsible for pulling data from the cloud; if there are no changes to be synced, no notifications are sent. Table data and object data can be synced with different policies. See, e.g., writeSyncNow( ) and readSync-Now( ) which allow an app to sync data on-demand.

### Simba Client Data Store

The Simba Client Data Store (SDS) is responsible for storing app data on the mobile device's persistent storage. SDS needs to be efficient for storing objects of varied sizes and needs to provide primitives that are required for efficient syncing. In particular, we need to be able to quickly determine sub-object changes and sync them, instead of a full object sync.

FIG. 2 shows the exemplary SDS data layout. Table storage is implemented using SQLite with an additional data type representing an object identifier, which is used as a key for the object storage. Object storage is implemented using splitting objects into chunks and storing them in a key-value store that supports range queries, for example, LevelDB. Each chunk is stored as a KV-pair, with the key being a <object id, chunk number> tuple. An object's data is accessed by looking up the first chunk of the object and iterating the key-value store in key order. Splitting objects into chunks allows Simba to do network-efficient, fine-grained sync.

An LSM tree-based data structure is suitable for object data because it provides log-structured writes, resulting in good throughput for both appends and over-writes; optimizing for random writes is important for mobile apps. The log of the LSM tree structure is used to determine changes that need to be synced. VT-Tree is a variation of LSM trees that can be more efficient; we wish to consider it in the future.

### SimbaSync

Simba builds upon the sync framework of Izzy. We briefly discuss how Izzy does synchronization before describing our extensions for unified storage. In Izzy table storage, each row is a single unit of syncing. As shown in FIG. 3, every table has an associated version number. Whenever a row is modified, added, or removed on the server, the current version of the table is incremented and assigned to the row. Thus, the table version is the highest version among all of its rows and no two rows have the same version. During sync, the table versions of the client and the server are compared, and only rows having a higher version than the client's table version need to be sent to the client. Whenever a row is modified or added on the client, it is assigned a special version (−1), which marks it as a dirty row that hasn't been assigned a version yet. Once a row is synced with the server, it is assigned a real version and the client's table version is also updated to indicate that the client and the server are synced up to a particular table version.

In SDS, the rows in the table store are assigned versions in a similar manner. For objects, we leverage the log-structured key-value store to keep track of changes. In effect, we checkpoint the log at every server sync point and use the log to determine which chunks need to be synced the next time. Sing log entries are created both through client writes and via downstream sync, we need to distinguish between the two. Otherwise, log entries that are created due to downstream sync would needlessly be sent during upstream sync.

### Atomicity and Sync Policies

Simba supports atomic syncing of an entire row (both table and object data) over the network; this is a stronger guarantee than provided by existing sync services. We are currently investigating other forms of atomic updates, but in our prototype we do not yet provide multi-row or multi-table atomicity.

In practice, for network efficiency, mobile apps may give up on atomic row sync. For example, a photo-sharing app that uses Simba may want to sync album metadata (e.g., photo name and location) more frequently than photos, restrict photo transfer over 3G, or fetch photos only on-demand. Simba allows table and object data to have separate sync policies. A sync policy specifies the frequency of sync and the “minimum” choice of network to use. Simba also supports local-only tables (no sync), and sync-on-demand.

For downstream sync, even when different table and object sync policies are used, Simba. Client can provide a consistent view of data to the app. If the object data is still unavailable or stale by the time a client app reads a row, the call will block until the object is fetched from the cloud. Similar semantics are infeasible for upstream sync since the server cannot assume client availability. How-ever, some apps may still prefer to do non-atomic up-dates in the upstream direction for the sake of network efficiency/expediency; this choice is left to the app via the atomic sync flag.

### Writing a Simba App

We now present an example of how one would write an Simba app for Android, to show the ease of mobile app development. We take the example of a photo-sharing app that maintains name, date, and location for the photos. The app would first create the table by specifying its schema (refer to the API in Table 2).

client.createTable(“photos”, “name VARCHAR,

date INTEGER, location FLOAT, photo OBJECT”
, Props.FULL_SYNC);

### Writing a Simba App

The next step is to register read and write sync with appropriate parameters. In this example, the app wants to sync photo metadata every 2 minutes over any network, and photos every 10 minutes over WiFi only.

client.registerWriteSync(“photos”, 120,

ConnState.ANY, 600,ConnState.WIFI);

client.registerReadSync(“photos”, 120,

ConnState.ANY, 600, ConnState.WIFI);

A photo can be added to the table with writeData( ). We set atomic sync to false so that photo metadata and the photo can be synced separately (non-atomically).

// get photo from camera
InputStream istream = getPhoto( );
client.writeData(“photos”, new String[ ]{“name=

Kopa”,“date=15611511”,“location=24.342”,“ photo=?”},
new InputStream[ ]{istream}, false};

Finally, a photo can be retrieved using a query:

ResultSet rs = client.readData(“photos”,

new String[ ] {“photo”}, “name=Kopa”) ;

// extract object's stream from result set
InputStream istream = rs.get(0).getColumn(0);

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. For example, FIG. 6 is a schematic block diagram depicting an exemplary computer system and associated structures for executing systems, structures and methods according to an aspect of the present disclosure. The exemplary computer systems contemplated by FIG. 6 include any of a variety including mobile, tablet, desktop etc. Those skilled in the art could implement various other feature combinations without departing from the scope and spirit of the invention.

1. A computer-implemented system, comprising:
an application program interface (API) including:
a write component configured to receive requests to store data from one or more applications executing on said system, said data to be stored having both structured (Table) and unstructured (Object) data, said data stored in a single unified data store;
a read component configured to receive requests to retrieve data from one or more applications executing on said system, said data to be retrieved having both structured and unstructured data, said data stored in the single unified data store; and
a processor and a computer-readable storage medium storing instructions that, when executed by the processor, cause the processor to implement at least one of the write component, the read component.

2. A computer-implemented system according to claim 1 further comprising:
a synchronization component which interacts with the API, the unified data store and a network manager component including one or more shared connections to synchronize the data stored in the unified store with a cloud server data store;
wherein the processor and computer-readable storage medium store instructions that, when executed by the processor, cause the processor to implement at least one of the write component, the read component, the synchronization component and network manager component.

3. The computer implemented method according to claim 2, wherein any dependencies between tables and objects are automatically maintained and enforced in the single unified data store and during synchronization.

4. The computer-implemented system according to claim 3 wherein said object data is split into a plurality of chunks and stored in the unified store as a key-value store.

5. The computer-implemented system according to claim 4 wherein rows of a table are assigned version numbers only after synchronization.

6. The computer-implemented system according to claim 2 wherein tables and objects are synchronized independently.
